(19) United States
(12) Patent Application Publication
(10) Pub. No.: US 2019/0140589 A1
(43) Pub. Date: May 9, 2019

(54) COMPUTER DEVICE AND METHOD FOR DETERMINING WHETHER A SOLAR ENERGY PANEL ARRAY IS ABNORMAL

(71) Applicant: Institute For Information Industry, Taipei (TW)

(72) Inventors: Chia-shin YEN, New Taipei City (TW); Jen-Chih WANG, Nantou County (TW); Chien-Hsiang CHEN, New Taipei City (TW)

(21) Appl. No.: 15/867,606

(22) Filed: Jan. 10, 2018

(30) Foreign Application Priority Data
Nov. 3, 2017 (TW) 106138151

(51) Int. Cl. H02S 50/00; G06F 17/50

(52) U.S. Cl. CPC H02S 50/00; H02S 40/32; G06F 17/5009

(57) ABSTRACT

Embodiments relate to a computer device and a method for determining whether a solar energy panel array is abnormal. In the embodiments, the computer device uses a current power generation calculation model to calculate a set of current reference power generation parameters of the solar energy panel array according to a set of current environment parameters of the solar energy panel array. The computer device also defines a power generation indicator for the solar energy panel array according to a contrast between a set of current actual power generation parameters of the solar energy panel array and the set of current reference power generation parameters, and determines whether the solar energy panel array is abnormal according to the power generation indicator.

### PRIORITY

This application claims priority to Taiwan Patent Application No. 106138151 filed on Nov. 3, 2017, which is hereby incorporated by reference in its entirety.

### FIELD

Embodiments of the present invention relate to a computer device and a determining method. More particularly, the embodiments of the present invention relate to a computer device and a method for determining whether a solar energy panel array is abnormal.

### BACKGROUND

Solar power generation is a method for power generation by converting energy of sunlight to electric energy. In order to achieve solar power generation, a solar energy system may practically comprise a plurality of solar energy panels connected in series, wherein each of the solar energy panels may comprise a plurality of solar energy cells, and these solar energy cells are configured to convert the energy of sunlight to the electric energy. Abnormality may occur during the operation of the solar energy system, and whether the solar energy system is abnormal is generally determined according to the total power generation of the solar energy system. For example, if the total power generation of the solar energy system is below a total power generation threshold, then it is determined that the solar energy system is abnormal. However, since whether the solar energy system is abnormal is determined according to the total power generation of the solar energy system, which part of the solar energy system is abnormal cannot be reflected explicitly.

On the other hand, the total power generation of the solar energy system is extremely sensitive to weather variation, so whether the solar energy system is abnormal is often misjudged due to the factor of weather variation when it is determined according to the total power generation of the solar energy system. For example, the solar energy system may be wrongly determined as abnormal if the total power generation of the solar energy system reduces because it has been under the environment without sunlight for a long time. In other words, the abnormality category caused by weather variation cannot be identified in this way. Therefore, it is not an effective and accurate method to determine whether the solar energy system is abnormal according to the total power generation of the solar energy system.

Accordingly, it is important in the art to determine whether the solar energy system is abnormal more effectively and identify the abnormal part and the abnormality category more accurately.

### SUMMARY

In order to solve at least the aforesaid problem, the disclosure provides a computer device for determining whether a solar energy panel array is abnormal. The computer device may comprise a storage and a processor electrically connected to the storage. The storage may be configured to store a current power generation calculation model, and a set of current actual power generation parameters and a set of current environment parameters of the solar energy panel array. The processor may be configured to use the current power generation calculation model to calculate a set of current reference power generation parameters of the solar energy panel array according to the set of current environment parameters. The processor may be further configured to define a power generation indicator for the solar energy panel array by a contrast between the set of current actual power generation parameters and the set of current reference power generation parameters, and determine whether the solar energy panel array is abnormal according to the power generation indicator.

In order to solve at least the aforesaid problem, the disclosure also provides a method for determining whether a solar energy panel array is abnormal. The method may comprise the following steps:
using a current power generation calculation model, by a computer device, to calculate a set of current reference power generation parameters of the solar energy panel array according to a set of current environment parameters of the solar energy panel array; and
defining, by the computer device, a power generation indicator for the solar energy panel array by a contrast between a set of current actual power generation parameters and the set of current reference power generation parameters of the solar energy panel array, and determining, by the computer device, whether the solar energy panel array is abnormal according to the power generation indicator.

In certain embodiments, it is determined whether respective solar energy panel arrays in the solar energy system are abnormal instead of determining whether the whole solar energy system is abnormal. Therefore, when it is determined that the solar energy system is abnormal, which solar energy panel array(s) in the solar energy system is/are abnormal can also be determined explicitly, and this will facilitate the subsequent repair of the abnormal solar energy panel array. On the other hand, in the embodiments of the present invention, a power generation indicator for determining whether a solar energy panel array is abnormal is relevant to a contrast between a set of current actual power generation parameters and a set of current reference power generation parameters of the solar energy panel array, and the set of current reference power generation parameters is relevant to a set of current environment parameters of the solar energy panel array. The set of environment parameters may comprise various parameters relevant to weather variation, so it is equivalent to that the power generation indicator for determining whether the solar energy panel array is abnormal has taken the factor of weather variation into consideration. Accordingly, in the embodiments of the present invention, the probability of wrongly determining that the solar energy panel array is abnormal can be effectively reduced. Moreover, during the identification of the abnormality categories, the embodiments of the present invention not only can identify the abnormality category caused by equipment damage, but also can identify other abnormality categories without the influence of weather variation (e.g., the sunshine amount variation).

It shall be appreciated that, this summary is not intended to encompass all embodiments of the present invention but is provided only to present certain examples of the present invention in a simple form and as an introduction to the following detailed description.

### BRIEF DESCRIPTION OF THE DRAWINGS

FIG. 1 illustrates a solar energy system in one or more embodiments of the present invention;

FIG. 2 illustrates a computer device for determining whether a solar energy panel array is abnormal in one or more embodiments of the present invention;

FIG. 3 illustrates a time course of the solar energy panel array in one or more embodiments of the present invention;

FIG. 4 illustrates a method for determining abnormality categories of a solar energy panel array in one or more embodiments of the present invention;

FIG. 5 illustrates a plurality of abnormality categories of the solar energy panel array in one or more embodiments of the present invention; and

FIG. 6 illustrates a method for determining whether a solar energy panel array is abnormal in one or more embodiments of the present invention.

### DETAILED DESCRIPTION

Embodiments of the present invention described in the examples below are not intended to limit the present invention to any specific example, embodiment, environment, applications, structures, processes or steps described in these example embodiments. In the attached drawings, elements unrelated to the present invention are omitted from depiction; and dimensions of elements and proportional relationships among individual elements in the attached drawings are only exemplary examples but not intended to limit the present invention. Unless stated particularly, same (or similar) element symbols may correspond to same (or similar) elements in the following description.

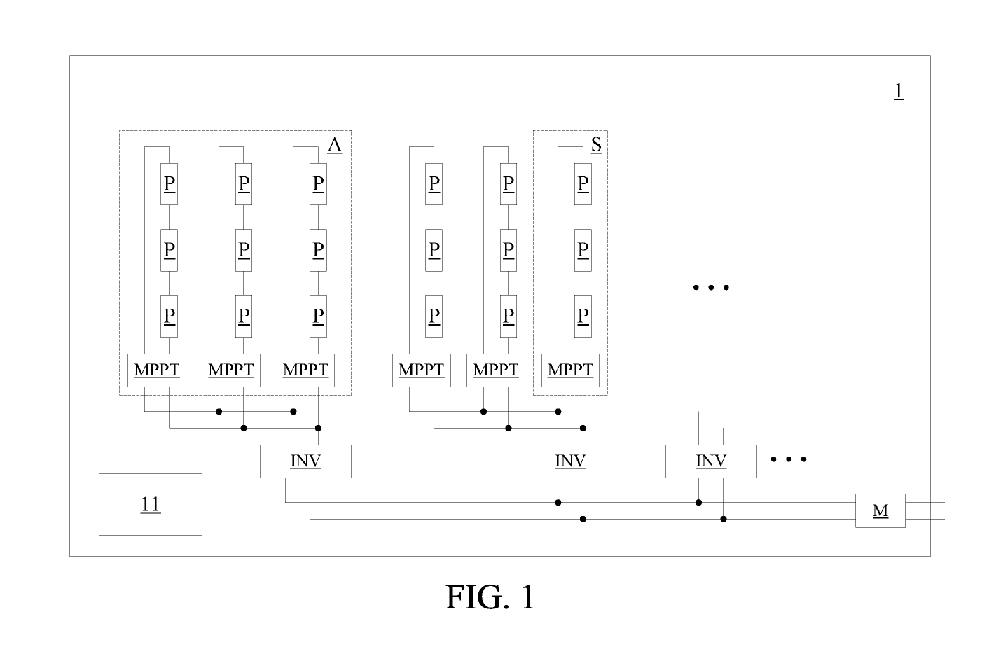

FIG. 1 illustrates a solar energy system in one or more embodiments of the present invention. Contents shown in FIG. 1 are only for purpose of illustrating embodiments of the present invention instead of limiting the present invention. Referring to FIG. 1, a solar energy system 1 may comprise a plurality of solar energy panels P, a plurality of maximum power point trackers MPPT, a plurality of inverters INV, a total power generation meter M and a sensor 11.

As shown in FIG. 1, each solar energy panel P may comprise a plurality of solar energy cells (not shown) so as to convert energy of sunlight to electric energy through the photovoltaic effect. A plurality of solar energy panels P connected in series and one maximum power point tracker MPPT may form a solar energy panel string S to provide a direct current output. The maximum power point tracker MPPT in each solar energy panel string S may be a DC to DC converter, and it may calculate the maximum power point of the solar energy panel string S via various methods which are for example but not limited to: a perturbation and observation method, an incremental conductance method, a current scanning method, a constant voltage method or the like. Each maximum power point tracker MPPT may output direct-current output power generated by all solar energy panels P connected in series with the maximum power point tracker MPPT. A plurality of solar energy panel string S may form one solar energy panel array A and may be connected to one inverter INV. Each inverter INV may be an electronic element converting direct current into alternating current using a high-frequency bridge circuit, and it may be for example but not limited to: a half bridge inverter, a full bridge inverter and a three-phase bridge type inverter or the like. Therefore, each inverter INV may convert the direct-current output of the solar energy panel array A connected with the inverter INV into an alternating-current output, and transmit the alternating-current output to the total power generation meter M. In some embodiments, each inverter INV may further record the actual power generation of the solar energy panel array A connected with the inverter INV.

The sensor 11 may comprise one or more equipments for sensing various environment parameters of an environment where the solar energy system 1 is located. For example, the sensor 11 may arbitrarily comprise a thermometer, an illuminometer, a humidometer, an air quality monitor or the like, wherein the thermometer may be used to sense temperature parameters of the environment where the solar energy system 1 is located, the illuminometer may be used to sense illuminance parameters of the environment where the solar energy system 1 is located, the humidometer may be used to sense humidity parameters of the environment where the solar energy system 1 is located, and the air quality monitor may be used to sense air quality parameters of the environment where the solar energy system 1 is located.

The connection mentioned with reference to FIG. 1 above may be direct connection (i.e., connection not via other elements with specific functions) or indirect connection (i.e., connection via other elements with specific functions) depending on different requirements.

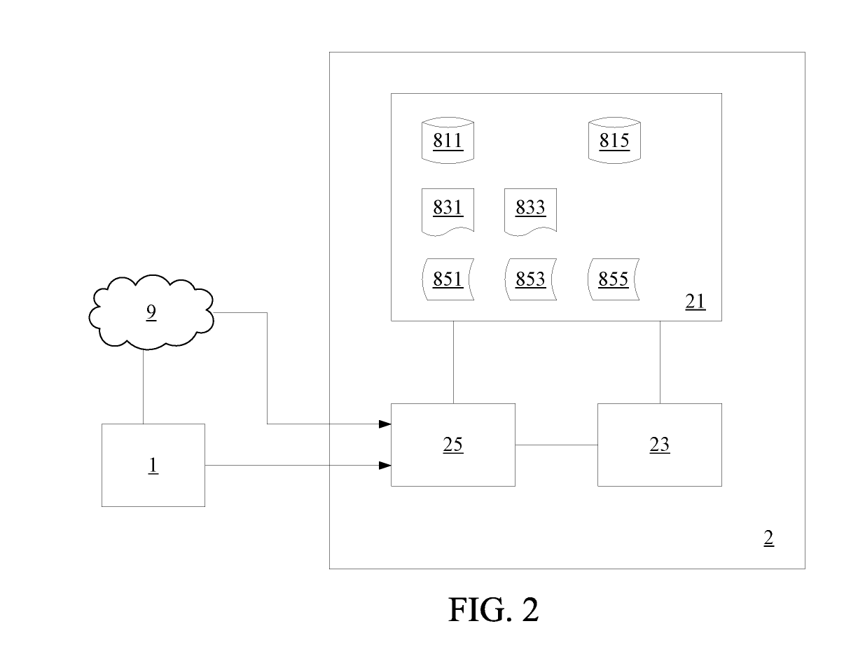

FIG. 2 illustrates a computer device for determining whether a solar energy panel array is abnormal in one or more embodiments of the present invention. Contents shown in FIG. 2 are only for purpose of illustrating embodiments of the present invention instead of limiting the present invention. Referring to FIG. 2, a computer device 2 may comprise a storage 21 and a processor 23. In some embodiments, the computer device 2 further comprises a data transmission interface 25. The storage 21, the processor 23 and the data transmission interface 25 may be connected with each other, and the connection among these three elements may be direct connection (i.e., connection not via other elements with specific functions) or indirect connection (i.e., connection via other elements with specific functions). For example, the storage 21 may be directly connected to the data transmission interface 25 or indirectly connected to the data transmission interface 25 via the processor 23.

The processor 23 may be one of various microprocessors or microcontrollers capable of signal processing. The microprocessor or the microcontroller is a kind of programmable specific integrated circuit that is capable of operating, storing, outputting/inputting or the like. Moreover, the microprocessor or the microcontroller can receive and process various coded instructions, thereby performing various logical operations and arithmetical operations and outputting corresponding operation results.

The storage 21 may comprise primary memories (also called main memories or internal memories) which are usually called memories for short, and the memories at this level directly communicate with the processor 23. The processor 23 may read instruction sets stored in the primary memories, and executes these instruction sets if needed. The storage 21 may further comprise secondary memories (which are also called external memories or auxiliary memories), and the secondary memories connect to the processor 23 through I/O channels of the memories instead of directly connecting to the processor 23, and use a data buffer to transmit data to the primary memories. The data in the secondary memories does not disappear even in the case without power supply (i.e., is non-volatile). The secondary memories may for example be various types of hard disks, optical disks or the like. The storage 21 may also comprise a third-level storage device, i.e., a storage device that can be inserted into or pulled out from a computer directly, e.g., a mobile disk.

The data transmission interface 25 may comprise various network interfaces for connecting the computer device 2 to the solar energy system 1 shown in FIG. 1 and/or to a network 9 (any wireless network and/or any wired network), which are for example but not limited to: an Ethernet communication interface, an Internet communication interface, a Wi-Fi network communication interface, an LTE network communication interface or the like.

In the case where the data transmission interface 25 connects to the solar energy system 1 shown in FIG. 1, the computer device 2 may directly receive various kinds of data (including data sensed by the sensor 11) from the solar energy system 1 via the data transmission interface 25. In the case where the data transmission interface 25 does not connect to the solar energy system 1 shown in FIG. 1 but the network 9 connects to the solar energy system 1 shown in FIG. 1, the computer device 2 may receive various kinds of data (including data sensed by the sensor 11) from the solar energy system 1 via the data transmission interface 25 and the network 9.

In some embodiments, the computer device 2 may further comprise an input/output interface (not shown) which may be for example but not limited to: a mouse, a trace ball, a touch pad, a keyboard, a scanner, a microphone, a user interface, a screen, a touch screen, a projector or the like. The input/output interface may be directly or indirectly connected with the storage 21, the processor 23 and the data transmission interface 25. Through the input/output interface, the user may store external data into the storage 21 or output data stored in the storage 21 to the outside.

Still referring to FIG. 2, the storage 21 may be configured to store a current power generation calculation model 811. The current power generation calculation model 811 may be a regression analysis model, and the regression analysis model may be represented as an equation relevant to the power generation and environment parameters of the solar energy panel array A. The environment parameters may include various parameter categories which are for example but not limited to at least one of the following parameter categories: illuminance, temperature, humidity, air quality or the like. For example, the current power generation calculation model 811 may be represented as the following equation in the case where only a certain environment parameter (e.g., the illuminance) of the solar energy panel array A is taken in consideration:

y=a₁x₁+a₀ (₁)

where x₁ is the illuminance, y is the power generation, while a₁ and a₀ are regression coefficients generated in advance through regression analysis.

As another example, the current power generation calculation model 811 may be represented as the following equation in the case where two environment parameters (e.g., the illuminance and the temperature) of the solar energy panel array A are taken in consideration:

y=b₁xᵢ²+b₂x₁x₂+b₀ (2)

where x₁ is the illuminance, x₂ is the temperature, y is the power generation, while b₁, b₂ and b₀ are regression coefficients generated in advance through regression analysis.

In some embodiments, the processor 23 may not construct the current power generation calculation model 811 by itself. Instead, the current power generation calculation model 811 that has been constructed outside the computer device 2 is stored into the storage 21 directly. In some embodiments, the processor 23 may also construct the current power generation calculation model 811 by itself.

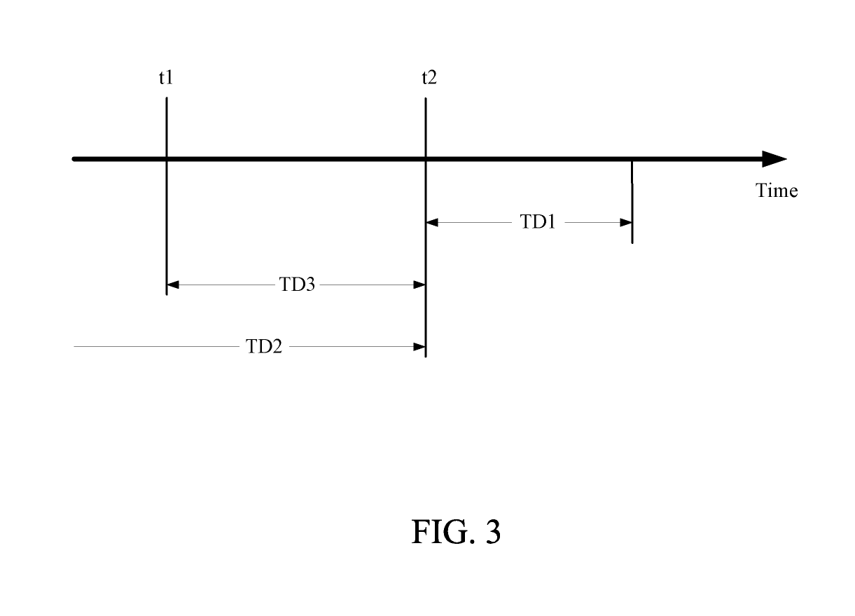

FIG. 3 illustrates a time course of a solar energy panel array in one or more embodiments of the present invention. Contents shown in FIG. 3 are only for purpose of illustrating embodiments of the present invention instead of limiting the present invention. Referring to FIG. 2 and FIG. 3, if the processor 23 may be configured to construct a current power generation calculation model 811 for a solar energy panel array A, the storage 21 may be configured to store a set of historical actual power generation parameters 833 and a set of historical environment parameters 853 of the solar energy panel array A. The set of historical environment parameters 853 may include various parameter categories which are for example but not limited to at least one of the following parameter categories: illuminance, temperature, humidity, air quality or the like.

The set of historical actual power generation parameters 833 and the set of historical environment parameters 853 may include a plurality of historical actual power generation values and a plurality of historical environment values of the solar energy panel array A that are sampled within a second time period TD2 respectively before a second time point t2. The length of the second time period TD2, the sampling number of the historical actual power generation values and the sampling number of the historical environment values may be set depending on different requirements. For example, if the second time point t2 is the time point at which the current power generation calculation model 811 is constructed, then the length of the second time period TD2 may be for example six months, one year, two years or the like, and the historical actual power generation values and the historical environment values may respectively comprise the power generation values at some specific time points of each day within the second time period TD2 (e.g., the average power generation of each hour from 9:00 am to 3:00 pm) and the environment values at some specific time points of each day within the second time period TD2 (e.g., the average environment value of each hour from 9:00 am to 3:00 pm).

The processor 23 may be configured to perform a regression analysis on the set of historical actual power generation parameters 833 and the set of historical environment parameters 853 to construct the current power generation calculation model 811, and store the current power generation calculation model 811 into the storage 21. Specifically, the processor 23 may utilize various regression analysis methods (e.g., a complex variable regression minimum square method) to input the set of historical actual power generation parameters 833 and the set of historical environment parameters 853 into a preset regression analysis model (e.g., the equation (1) or equation (2)), and then calculate regression coefficients of the preset regression analysis model (e.g., the regression coefficients aₗ and a₀ in the equation (1) or the regression coefficients b₁, b₂ and b₀ in the equation (2)), thereby constructing the current power generation calculation model 811.

Still referring to FIG. 2 and FIG. 3, the storage 21 may be configured to store a set of current actual power generation parameters 831 and a set of current environment parameters 851 of the solar energy panel array A. The set of current environment parameters 851 may include various parameter categories which are for example but not limited to at least one of the following parameter categories: illuminance, temperature, humidity, air quality or the like. The set of current actual power generation parameters 831 may comprise a plurality of current actual power generation values respectively corresponding to a plurality of specific time points within a first time period TD1 after the second time point t2, and the set of current environment parameters 851 may comprise a plurality of current environment values respectively corresponding to the specific time points within the first time period TD1 after the second time point t2. In the case where the current power generation calculation model 811 is constructed by the processor 23, the second time point t2 may be a certain time point after the current power generation calculation model 811 is constructed by the processor 23. In the case where the current power generation calculation model 811 is not constructed by the processor 23, the second time point t2 may be a certain time point after the current power generation calculation model 811 is stored into the storage 21.

The length of the first time period TD1 and a plurality of time points comprised in the first time period TD1 may be set depending on different requirements. For example, it is assumed that the second time point t2 is 8:00 am of a certain day, the first time period TD1 may be eight hours, and the first time period TD1 may comprise eight time points which are respectively 9:00 am, 10:00 am, 11:00 am, 12:00 am, 1:00 pm, 2:00 pm, 3:00 pm and 4:00 pm. As another example, it is assumed that the second time point t2 is 8:00 am of a certain day, the first time period TD1 may be nine hours, and the first time period TD1 may comprise three time points which are respectively 11:00 am, 2:00 pm and 5:00 pm.

The processor 23 may be configured to use the current power generation calculation model 811 to calculate a set of current reference power generation parameters of the solar energy panel array A according to the set of current environment parameters 851. Specifically, the processor 23 may input a plurality of current environment values of a plurality of specific time points comprised in the first time period TD1 respectively into the current power generation calculation model 811 (e.g., the equation (1) or the equation (2) of which the regression coefficients are known) to respectively calculate a plurality of current reference power generation values corresponding to the plurality of specific time points comprised in the first time period TD1 (e.g., the power generation y in the equation (1) or the equation (2) of which the regression coefficients are known), thereby obtaining the set of current reference power generation parameters.

After calculating the set of current reference power generation parameters of the solar energy panel array A, the processor 23 may be configured to define a power generation indicator for the solar energy panel array A by a contrast between the set of current actual power generation parameters 831 and the set of current reference power generation parameters. For example, the processor 23 may define a curve presented by a plurality of ratios of the set of current actual power generation parameters 831 to the set of current reference power generation parameters (a plurality of ratios obtained through dividing the actual power generation values by the plurality of reference power generation values) corresponding to the specific time points within the first time period TD1 as the power generation indicator. As described later, the processor 23 can determine whether the solar energy panel array A is abnormal and identify the abnormality category of the solar energy panel array A according to the power generation indicator.

Still referring to FIG. 2 and FIG. 3, in some embodiments, the storage 21 may be further configured to store a previous power generation calculation model 815 and a set of previous environment parameters 855 of the solar energy panel array A. The set of previous environment parameters 855 may comprise a plurality of previous environment values corresponding to a plurality of specific time points within a third time period TD3 between the first time point t1 and the second time point t2. The set of previous environment parameters 855 may include various parameter categories which are for example but not limited to at least one of the following parameter categories: illuminance, temperature, humidity, air quality or the like.

The processor 23 may not construct the previous power generation calculation model 815 by itself, or the processor 23 may construct the previous power generation calculation model 815 by itself. In the case where the previous power generation calculation model 815 is constructed by the processor 23, the first time point t1 may be a certain time point after the previous power generation calculation model 815 is constructed by the processor 23. In the case where the previous power generation calculation model 815 is not constructed by the processor 23, the first time point t1 may be a certain time point after the previous power generation calculation model 815 is stored into the storage 21. The length of the third time period TD3 and the sampling number of the previous environment values may be set depending on different requirements. For example, the length of the third time period TD3 may be one month, three months, six months, one year, or more than one year. The previous environment values may comprise the environment values at some specific time points of each day within the third time period TD3 (e.g., the average environment value of each hour from 9:00 am to 3:00 pm).

The processor 23 may be configured to use the current power generation calculation model 811 to calculate a set of first power generation parameters of the solar energy panel array A according to the set of previous environment parameters 855, and use the previous power generation calculation model 815 to calculate a set of second power generation parameters of the solar energy panel array A according to the set of previous environment parameters 855. Then, the processor 23 may determine whether to calculate the set of current reference power generation parameters of the solar energy panel array A by comparing the set of first power generation parameters and the set of second power generation parameters.

Specifically, the processor 23 may input a plurality of previous environment values sampled within the third time period TD3 respectively into the current power generation calculation model 811 (e.g., the equation (1) or the equation (2) of which the regression coefficients are known) to calculate a plurality of first power generation values (e.g., the power generation y in the equation (1) or the equation (2) of which the regression coefficients are known), and these first power generation values are the set of first power generation parameters. Moreover, the processor 23 may input the plurality of previous environment values sampled within the third time period TD3 respectively into the previous power generation calculation model 815 (e.g., the equation (1) or the equation (2) of which the regression coefficients are known) to calculate a plurality of second power generation values (e.g., the power generation y in the equation (1) or the equation (2) of which the regression coefficients are known), and these second power generation values are the set of second power generation parameters. Then, the processor 23 may calculate an average of a plurality of ratios of the set of first power generation parameters to the set of second power generation parameters (i.e., a plurality of ratios obtained through dividing the first power generation values by the second power generation values), and decide whether to calculate the set of current reference power generation parameters (i.e., whether to calculate the power generation indicator) of the solar energy panel array A according to the average.

If the difference between the set of first power generation parameters and the set of second power generation parameters is too large (i.e., the average exceeds a preset threshold), then it means that the difference between the current power generation calculation model 811 and the previous power generation calculation model 815 is too large, and thus the processor 23 may determine that the current power generation calculation model 811 is not suitable for calculating the set of current reference power generation parameters of the solar energy panel array A (i.e., is not suitable for calculating the power generation indicator of the solar energy panel array A). One reason for the difference between the current power generation calculation model 811 and the previous power generation calculation model 815 being too large may be that the degradation degree of the solar energy panel array A becomes abnormal. In this case, the processor 23 may identify the solar energy panel array A as having degradation abnormality.

The set of historical actual power generation parameters 833, the set of historical environment parameters 853, the set of current actual power generation parameters 831, the set of current environment parameters 851 and the set of previous environment parameters 855 stored in the storage 21 may be provided through the data transmission interface 25. The set of historical actual power generation parameters 833, the set of historical environment parameters 853, the set of current actual power generation parameters 831, the set of current environment parameters 851 and the set of previous environment parameters 855 stored in the storage 21 may also be inputted into the computer device 2 by the user.

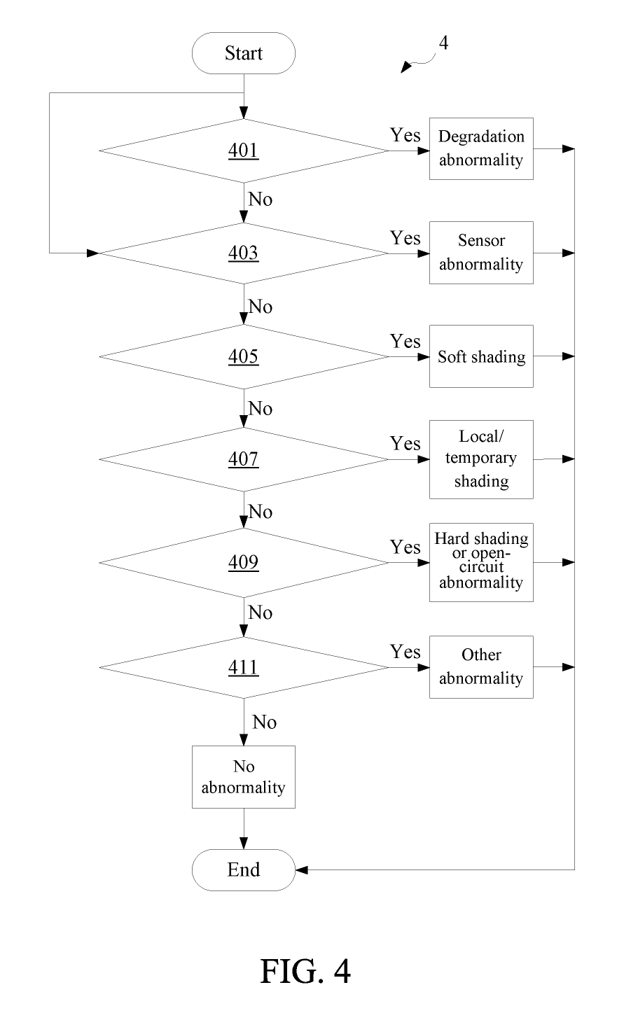

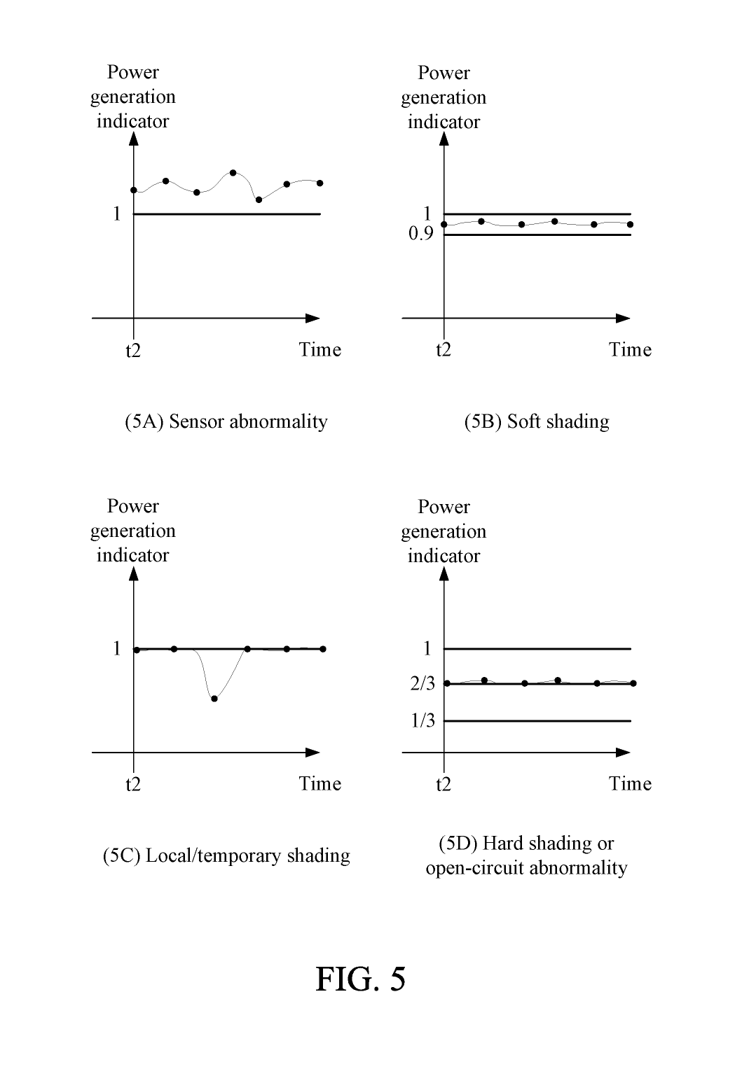

FIG. 4 illustrates a method for determining abnormality categories of a solar energy panel array in one or more embodiments of the present invention, and FIG. 5 illustrates a plurality of abnormality categories of a solar energy panel array in one or more embodiments of the present invention. Contents shown in FIG. 4 and FIG. 5 are only for purpose of illustrating embodiments of the present invention instead of limiting the present invention. Referring to FIG. 4 to FIG. 5, the processor 23 may determine whether the solar energy panel array A is abnormal and identify the abnormality category thereof according to an identification method 4.

An identification step 401 may be used to determine whether the degradation of the solar energy panel array A is abnormal. As described previously, the computer device 2 may calculate an average of ratios of the set of first power generation parameters to the set of second power generation parameters (i.e., a plurality of ratios obtained through dividing the first power generation values by the second power generation values), and determine whether the degradation of the solar energy panel array A is abnormal according to the average. If it is determined that the degradation of the solar energy panel array A is abnormal, then the power generation indicator may not be calculated. For example, if the average is smaller than a degradation threshold (e.g., smaller than 0.9), then the computer device 2 may determine that the solar energy panel array A is abnormal and identify the abnormal status thereof as degradation abnormality. The degradation abnormality described herein means that the degradation degree of the solar energy panel array A exceeds the normal degradation degree that is caused by natural wearing, and the reason of the degradation abnormality is not limited.

If the result of the identification step 401 is no, then another identification step 403 is further executed. However, in some embodiments, the identification step 401 may be omitted and the identification method 4 may directly begin from the identification step 403.

As described above, the computer device 2 may use the current power generation calculation model 811 to calculate a set of current reference power generation parameters of the solar energy panel array A according to the set of current environment parameters 851, and define a power generation indicator for the solar energy panel array A by a contrast between the set of current actual power generation parameters 831 and the set of current reference power generation parameters.

In the case where the sensor 11 is normal, the actual power generation of the solar energy panel array A is usually smaller than the reference power generation calculated according to the current power generation calculation model 811. Therefore, in the identification step 403, if the values of the power generation indicator at each of the time points within the first time period TD1 and an average of the values are all greater than a first preset value, then it may mean that the actual power generation of the solar energy panel array A is greater than the reference power generation calculated according to the current power generation calculation model 811. In this case, the computer device 2 can determine that the solar energy panel array A is abnormal and identify the abnormality category thereof as sensor abnormality. The sensor abnormality described herein encompasses the abnormality of the sensor 11 caused by various reasons which are for example but not limited to: smudges on the surface of the sensor 11, failure in calibrating of the sensor 11, or the malfunction of the sensor 11 or the like. For example, referring to (5A) in FIG. 5, if the values of the power generation indicator at each of the time points from the second time point t2 and an average of the values are all greater than the first preset value (e.g., greater than 1), then the computer device 2 can determine that the solar energy panel array A is abnormal and identify the abnormality category thereof as sensor abnormality. If the result of the identification step 403 is no, then another identification step 405 is further executed.

In the identification step 405, if the values of the power generation indicator at each of the time points within the first time period TD1 are all smaller than the first present value but are all greater than a second preset value, then the computer device 2 can determine that the solar energy panel array A is abnormal and identify the abnormality category thereof as soft shading abnormality. The soft shading abnormality described herein refers to a kind of abnormality that it is hard for the solar energy panel array A to generate the hot spot effect due to dust or semi-transparent smudges on the surface of the solar energy panel array A. For example, referring to (5B) in FIG. 5, if the values of the power generation indicator at each of the time points from the second time point t2 all range from the first preset value to the second preset value (e.g., each of the values is smaller than 1 but larger than 0.9), then the computer device 2 can determine that the solar energy panel array A is abnormal and identify the abnormality category thereof as soft shading abnormality. If the result of the identification step 405 is no, then another identification step 407 is further executed.

In the identification step 407, if the value(s) of the power generation indicator at some time point(s) within the first time period TD1 is/are smaller than the first present value but the values thereof at other time points are all close to the first preset value, then the computer device 2 can determine that the solar energy panel array A is abnormal and identify the abnormality category thereof as local abnormality and/or temporary abnormality. The local abnormality and/or temporary abnormality described herein refers to a kind of abnormality when the solar energy panel array A is locally or temporarily shaded, and it may encompass various reasons for the solar energy panel array A being locally or temporarily shaded, which are for example but not limited to: buildings, plants and clouds locally or temporarily shade the solar energy panel array A due to variation of the direction of sunlight illumination. For example, referring to (5C) in FIG. 5, if the value of the power generation indicator at only one time point from the second time point t2 is smaller than the first preset value (e.g., smaller than 1) but the values thereof at other time points are all close to the first preset value (e.g., close to 1), then the computer device 2 can determine that the solar energy panel array A is abnormal and identify the abnormality category thereof as local abnormality and/or temporary abnormality. If the result of the identification step 407 is no, then another identification step 409 is further executed.

In the identification step 409, if the values of the power generation indicator at each of the time points within the first time period TD1 are all close to a particular value, and the particular value is an integral multiple of the value obtained through dividing the first preset value by the number of solar energy panel strings S comprised in the solar energy panel array A, then the computer device 2 can determine that the solar energy panel array A is abnormal and identify the abnormality category thereof as hard shading or open-circuit abnormality. If the solar energy panel array A includes three solar energy panel strings S, then the particular value may be an integral multiple of ⅓, i.e., ⅓ or ⅔. The hard shading or open-circuit abnormality described herein refers to a kind of abnormality that some solar energy panel string(s) S is/are out of operation due to the malfunction of some solar energy panel(s) P in the solar energy panel array A. For example, referring to (5D) in FIG. 5, if the solar energy panel array A comprises three solar energy panel strings S and the values of the power generation indicator at each of the time points from the second time point t2 are all close to ⅔ or ⅓, then the computer device 2 can determine that the solar energy panel array A is abnormal and identify the abnormality category thereof as hard shading or open-circuit abnormality. If the values of the power generation indicator at each of the time points are all close to ⅔, then it means that hard shading or open-circuit abnormality occurs to a certain string among the three solar energy panel strings S comprised in the solar energy panel array A. If the values of the power generation indicator at each of the time points are all close to ⅓, then it means that hard shading or open-circuit abnormality occurs to two strings among the three solar energy panel strings S comprised in the solar energy panel array A. If the result of the identification step 409 is no, then another identification step 411 is further executed.

In the identification step 411, if the values of the power generation indicator at each of the time points within the first time period TD1 are all smaller than the second preset value, then the computer device 2 can determine that the solar energy panel array A is abnormal and identify the abnormality category as other abnormalities (which are for example but not limited to poor contact, short circuit, sub-fissure, electric arc, soft shading accumulation or various composite abnormalities). Otherwise, the computer device 2 can identify the solar energy panel array A as having no abnormality.

The order in which the identification steps 403 to 411 shown in FIG. 4 are executed may be adjusted arbitrarily depending on different requirements. Additionally, in some embodiments, one or ones of the identification steps 403 to 411 shown in FIG. 4 may be omitted depending on different requirements. In some embodiments, one or more identification steps satisfying other conditions may be added to the identification method 4 shown in FIG. 4.

In some embodiments, any of the preset values described above may also be replaced by a preset interval, and the preset interval may comprise an upper limit value and a lower limit value. Additionally, determining whether the power generation indicator is greater than a certain preset value may be changed into determining whether the power generation indicator is greater than the upper limit value of the corresponding preset interval; determining whether the power generation indicator is smaller than a certain preset value may be changed into determining whether the power generation indicator is smaller than the lower limit value of the corresponding preset interval; and determining whether the power generation indicator is close to a certain preset value may be changed into determining whether the power generation indicator falls within a corresponding preset interval. For example, a preset interval with a lower limit value of 0.95 and an upper limit value of 1.05 may be adopted to replace the preset value 1, thereby increasing the error tolerance of the determining operations.

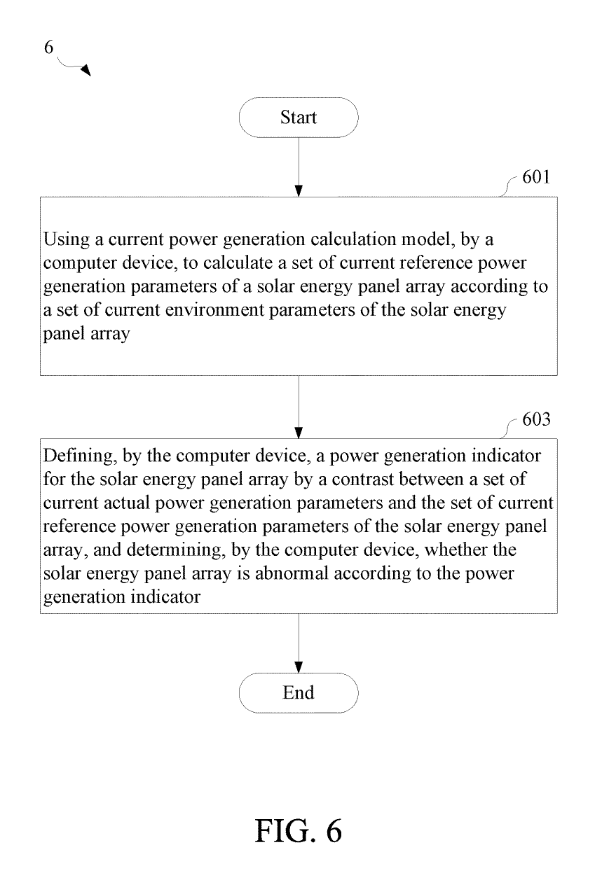

FIG. 6 illustrates a method for determining whether a solar energy panel array is abnormal in one or more embodiments of the present invention. Contents shown in FIG. 6 are only for purpose of illustrating embodiments of the present invention instead of limiting the present invention. Referring to FIG. 6, a method 6 for determining whether a solar energy panel array is abnormal may comprise the following steps:
using a current power generation calculation model, by a computer device, to calculate a set of current reference power generation parameters of the solar energy panel array according to a set of current environment parameters of the solar energy panel array (labeled as step 601); and
defining, by the computer device, a power generation indicator for the solar energy panel array by a contrast between a set of current actual power generation parameters and the set of current reference power generation parameters of the solar energy panel array, and determining, by the computer device, whether the solar energy panel array is abnormal according to the power generation indicator (labeled as step 603).

In some embodiments, the method 6 may further comprise the following step of: performing, by the computer device, a regression analysis on a set of historical actual power generation parameters and a set of historical environment parameters of the solar energy panel array to construct the current power generation calculation model.

In some embodiments, the method 6 may further comprise the following steps of: performing, by the computer device, a regression analysis on a set of historical actual power generation parameters and a set of historical environment parameters of the solar energy panel array to construct the current power generation calculation model; and receiving and storing, by the computer device, the set of current actual power generation parameters, the set of current environment parameters, the set of historical actual power generation parameters and the set of historical environment parameters from the solar energy panel array.

In some embodiments, the method 6 may further comprise the following steps of: using the current power generation calculation model, by the computer device, to calculate a set of first power generation parameters of the solar energy panel array according to a set of previous environment parameters of the solar energy panel array; using a previous power generation calculation model, by the computer device, to calculate a set of second power generation parameters of the solar energy panel array according to the set of previous environment parameters of the solar energy panel array; and determining, by the computer device, whether to calculate the set of current reference power generation parameters of the solar energy panel array by comparing the set of first power generation parameters and the set of second power generation parameters.

In some embodiments, in the method 6, the set of current environment parameters may include at least one of the following parameter categories: illuminance, temperature and humidity.

In some embodiments, the method 6 may further comprise the following step of: identifying, by the computer device, an abnormality category of the solar energy panel array according to the power generation indicator.

In some embodiments, the method 6 may be implemented on the computer device 2. All corresponding steps of the method 6 may be clearly appreciated by a person having ordinary skill in the art based on the above description of the computer device 2, and thus will not be further described herein.

According to the above descriptions, in the embodiments of the present invention, it is respectively determined whether each of the solar energy panel arrays in the solar energy system is abnormal instead of determining whether the whole solar energy system is abnormal. Therefore, when it is determined that the solar energy system is abnormal, which solar energy panel array(s) in the solar energy system is/are abnormal can also be determined explicitly, and this will facilitate the subsequent repair of the abnormal solar energy panel array. On the other hand, in the embodiments of the present invention, a power generation indicator for determining whether a solar energy panel array is abnormal is relevant to a contrast between a set of current actual power generation parameters and a set of current reference power generation parameters of the solar energy panel array, and the set of current reference power generation parameters is relevant to a set of current environment parameters of the solar energy panel array. The set of environment parameters may comprise various parameters relevant to weather variation, so it is equivalent to that the power generation indicator for determining whether the solar energy panel array is abnormal has taken the factor of weather variation into consideration. Accordingly, in the embodiments of the present invention, the probability of wrongly determining that the solar energy panel array is abnormal can be effectively reduced. Moreover, during the identification of the abnormality categories, the embodiments of the present invention not only can identify the abnormality category caused by equipment damage, but also can accurately identify the abnormality category caused by weather variation.

The above disclosure is related to the detailed technical contents and inventive features thereof. A person having ordinary skill in the art may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A computer device for determining whether a solar energy panel array is abnormal, comprising:
a storage, being configured to store a current power generation calculation model, and a set of current actual power generation parameters and a set of current environment parameters of the solar energy panel array; and
a processor electrically connected to the storage, being configured to:
use the current power generation calculation model to calculate a set of current reference power generation parameters of the solar energy panel array according to the set of current environment parameters; and
define a power generation indicator for the solar energy panel array by a contrast between the set of current actual power generation parameters and the set of current reference power generation parameters, and determine whether the solar energy panel array is abnormal according to the power generation indicator.

2. The computer device of claim 1, wherein:
the storage is further configured to store a set of historical actual power generation parameters and a set of historical environment parameters of the solar energy panel array; and
the processor is further configured to perform a regression analysis on the set of historical actual power generation parameters and the set of historical environment parameters to construct the current power generation calculation model, and store the current power generation calculation model into the storage.

3. The computer device of claim 2, further comprising a data transmission interface, wherein:
the data transmission interface is electrically connected to the storage and is configured to receive the set of current actual power generation parameters, the set of current environment parameters, the set of historical actual power generation parameters and the set of historical environment parameters of the solar energy panel array.

4. The computer device of claim 3, wherein the data transmission interface is connected to a sensor of the solar energy panel array to receive the set of current actual power generation parameters, the set of current environment parameters, the set of historical actual power generation parameters and the set of historical environment parameters.

5. The computer device of claim 1, wherein:
the storage is further configured to store a previous power generation calculation model and a set of previous environment parameters of the solar energy panel array; and
the processor is further configured to:
use the current power generation calculation model to calculate a set of first power generation parameters of the solar energy panel array according to the set of previous environment parameters;
use the previous power generation calculation model to calculate a set of second power generation parameters of the solar energy panel array according to the set of previous environment parameters; and
determine whether to calculate the set of current reference power generation parameters of the solar energy panel array by comparing the set of first power generation parameters and the set of second power generation parameters.

6. The computer device of claim 1, wherein the set of current environment parameters include at least one of the following parameter categories: illuminance, temperature and humidity.

7. The computer device of claim 1, wherein the processor further identifies an abnormality category of the solar energy panel array according to the power generation indicator.

8. The computer device of claim 7, wherein the abnormality category is one of degradation abnormality, sensor abnormality, soft shading abnormality, local/temporary shading, hard shading or open-circuit abnormality, and other abnormalities.

9. The computer device of claim 1, wherein the set of current actual power generation parameters include a plurality of current actual power generation values respectively corresponding to a plurality of specific time points within a time period, the set of current environment parameters include a plurality of current environment values respectively corresponding to the specific time points within the time period, and the set of reference power generation parameters include a plurality of reference power generation values respectively corresponding to the specific time points within the time period.

10. The computer device of claim 9, wherein the processor defines a curve presented by a plurality of ratios of the current actual power generation values to the reference power generation values corresponding to the specific time points within the time period as the power generation indicator.

11. A method for determining whether a solar energy panel array is abnormal, comprising:
using a current power generation calculation model, by a computer device, to calculate a set of current reference power generation parameters of the solar energy panel array according to a set of current environment parameters of the solar energy panel array; and
defining, by the computer device, a power generation indicator for the solar energy panel array by a contrast between a set of current actual power generation parameters and the set of current reference power generation parameters of the solar energy panel array, and determining, by the computer device, whether the solar energy panel array is abnormal according to the power generation indicator.

12. The method of claim 11, further comprising:
performing, by the computer device, a regression analysis on a set of historical actual power generation parameters and a set of historical environment parameters of the solar energy panel array to construct the current power generation calculation model.

13. The method of claim 12, further comprising:
receiving and storing, by the computer device, the set of current actual power generation parameters, the set of current environment parameters, the set of historical actual power generation parameters and the set of historical environment parameters from the solar energy panel array.

14. The method of claim 13, wherein the computer device receives the set of current actual power generation parameters, the set of current environment parameters, the set of historical actual power generation parameters and the set of historical environment parameters from a sensor of the solar energy panel array.

15. The method of claim 11, further comprising:
using the current power generation calculation model, by the computer device, to calculate a set of first power generation parameters of the solar energy panel array according to a set of previous environment parameters of the solar energy panel array;
using a previous power generation calculation model, by the computer device, to calculate a set of second power generation parameters of the solar energy panel array according to the set of previous environment parameters of the solar energy panel array; and
determining, by the computer device, whether to calculate the set of current reference power generation parameters of the solar energy panel array by comparing the set of first power generation parameters and the set of second power generation parameters.

16. The method of claim 11, wherein the set of current environment parameters include at least one of the following parameter categories: illuminance, temperature and humidity.

17. The method of claim 11, further comprising:
identifying, by the computer device, an abnormality category of the solar energy panel array according to the power generation indicator.

18. The method of claim 17, wherein the abnormality category is one of degradation abnormality, sensor abnormality, soft shading abnormality, local/temporary shading, hard shading or open-circuit abnormality, and other abnormalities.

19. The method of claim 11, wherein the set of current actual power generation parameters include a plurality of current actual power generation values respectively corresponding to a plurality of specific time points within a time period, the set of current environment parameters include a plurality of current environment values respectively corresponding to the specific time points within the time period, and the set of reference power generation parameters include a plurality of reference power generation values respectively corresponding to the specific time points within the time period.

20. The method of claim 19, wherein the computer device defines a curve presented by a plurality of ratios of the current actual power generation values to the reference power generation values corresponding to the specific time points within the time period as the power generation indicator.
